(19) United States
(12) Patent Application Publication
(10) Pub. No.: US 2026/0310303 A1
(43) Pub. Date: Oct. 8, 2026

(54) Gesture-Based Interface Plugin and Integration SDK for Web and App Environments

(71) Applicant: Oladayo Ayokunle Luke, Campbell, CA (US)

(72) Inventor: Oladayo Ayokunle Luke, Campbell, CA (US)

(73) Assignee: Perdurable Group inc., Campbell, CA (US)

(21) Appl. No.: 19/646,573

(22) Filed: Apr. 14, 2026

Related U.S. Application Data
(63) Continuation-in-part of application No. 19/040,873, filed on Jan. 30, 2025.

(51) Int. Cl. G06F 3/01; G06F 9/451; G06V 10/764; G06V 40/20

(52) U.S. Cl. CPC G06F 3/017; G06F 9/451; G06V 10/764; G06V 40/28

(57) ABSTRACT

A computer-implemented system and method for enabling touchless gesture-based interaction with a digital user interface are disclosed. A camera interface captures a sequence of image frames representing hand movements of a user. A gesture recognition engine executed on a client device processes the image frames to extract hand landmark data and classify the hand movements into predefined gesture types. A gesture-to-interface mapping module associates the predefined gesture types with corresponding user interface actions and binds the actions to target elements within a Document Object Model (DOM) using selector-based identifiers. An event injection module generates synthetic interface events corresponding to the user interface actions and applies the events to the target elements to effect execution of the actions without physical touch input. The system is implemented as a plugin interface or software development kit (SDK) configured for integration into a host application without modification of core application logic.

### CROSS-REFERENCE TO RELATED APPLICATION

This application is a Continuation-in-Part (CIP) of U.S. Non-Provisional patent application Ser. No. 19/040,873, filed Jan. 30, 2025.

The present application builds upon these prior disclosures by introducing a Gesture-Based Interface Plugin and Integration SDK designed to support gesture-driven interactions in web and mobile application environments. The invention standardizes developer integration through plugins and APIs, enabling seamless touchless interface adoption across diverse platforms.

### TECHNICAL FIELD

The present invention relates to human-computer interaction systems and software development frameworks. More particularly, it pertains to gesture-based user interface enhancement technologies and modular plugin architectures that allow developers to embed touchless input capabilities into existing web, mobile, or hybrid applications without the need for specialized hardware or backend AI infrastructure.

### BACKGROUND

U.S. patent application Ser. No. 19/040,873 (filed on Jan. 30, 2025), entitled “Unified System for Gesture Recognition, Text Generation, and Multi-Modal Communication,” discloses a comprehensive platform also referred to as Inclusive GPT that integrates gesture recognition with generative AI and multi-modal output strategies. The system focuses on advanced capabilities such as a three-stage gesture transformer architecture, real-time video generation, and federated learning for on-device privacy. The system integrates gesture recognition with multimodal input and output processing to enable coordinated interaction across multiple communication modalities.

The invention focuses on application-layer enhancements, including DOM-level gesture binding, pluggable command maps, and customizable input zones that support drag, click, scroll, typing, and authentication gestures. It addresses the gap in current gesture systems by offering low-latency, privacy-conscious, tools configured to enable integration into existing applications suitable for production-grade deployment across varied platforms and accessibility contexts.

### PRIOR ART

Existing solutions for gesture-based interaction in software applications often rely on proprietary hardware ecosystems, closed gesture libraries, or platform-specific development kits, limiting interoperability and adoption.

U.S. Pat. No. 8,942,870 describes a gesture control system integrated with specialized hardware sensors and does not support browser-native environments or generalized plugin architecture.

U.S. Pat. No. 9,197,599 discloses an SDK for gesture interaction on mobile devices but lacks extensibility to standard web forms or DOM-based control.

Various commercial products (e.g., Leap Motion, Kinect SDKs) provide gesture APIs; however, these are either discontinued or confined to proprietary hardware, with no portable browser-level implementation.

U.S. patent application Ser. No. 19/040,873, entitled “Unified System for Gesture Recognition, Text Generation, and Multi-Modal Communication,” discloses a platform that integrates gesture recognition with generative AI and multi-modal communication. While that invention focuses on gesture modeling and AI processing layers, it does not disclose developer-facing plugins, browser-native event emitters, or form-enhancing APIs for direct frontend.

The current invention addresses these limitations by offering a cross-platform, toolkit configured to enable integration into existing applications for gesture capture, interpretation, and UI binding using standard browser technologies and no specialized hardware.

### Unfulfilled Need

There remains a significant unmet need for a modular, cross-platform toolkit that enables developers to easily integrate gesture-based input into existing digital interfaces particularly for web forms, browser applications, and mobile environments without reliance on proprietary sensors or closed APIs.

Current gesture recognition systems lack seamless DOM-level control and plugin extensibility, making it difficult for third-party developers to retrofit gesture functionality into pre-existing interfaces. Additionally, few systems offer fine-grained gesture-to-UI element binding, such as detecting and validating specific gestures for text input, form submission, or drag-and-drop events.

Developers and organizations need a standardized, browser-compatible SDK and plugin suite that can inject touchless control features into web forms, buttons, and interface elements, while maintaining compatibility across devices and preserving user privacy through client-side gesture processing.

### Failure of Others

Existing gesture input systems often focus on niche environments such as gaming consoles, augmented reality headsets, or custom hardware (e.g., depth cameras), thereby lacking general applicability across conventional web and mobile platforms.

Prior art solutions fail to provide a developer-friendly method for binding gesture commands directly to standard HTML DOM elements, limiting their use in typical form-based applications or enterprise web systems.

Gesture recognition APIs that do exist are frequently closed-source, platform-dependent, or lack dynamic context awareness, making it difficult to customize behavior per user interface or enforce accessibility and validation rules.

None of the current solutions offer a gesture plugin or SDK that integrates cleanly with browser-native environments, supports secure interaction models, and allows low-code or no-code gesture augmentation of third-party applications.

### Problems With Prior Art

U.S. Pat. No. 8,942,870 describes a method of gesture-based control using specialized optical tracking systems. However, it lacks support for DOM-level integration in standard web environments and is not optimized for form-level interaction or plug-and-play extensibility across platforms.

U.S. Pat. No. 9,197,599 provides gesture recognition for electronic devices but is primarily oriented around predefined gestures tied to specific devices or applications, limiting dynamic gesture assignment or developer customization within web and mobile applications.

Commercial solutions such as Leap Motion and Microsoft Kinect SDKs offer robust tracking features, but they require proprietary hardware and do not provide browser-native plugins, APIs, or SDKs for developers to embed gesture logic directly into HTML, CSS, or JavaScript environments.

U.S. Patent No. Ser. No. 19/040,873 focuses on a multi-modal generative architecture that includes gesture input, but it is primarily oriented toward AI-enhanced gesture modeling and multimodal communication, rather than gesture binding for direct DOM-level interaction or plugin-based extensibility. It does not disclose reusable SDK or plugin components for third-party developer use.

### Serious Nature of the Problem

As digital interfaces proliferate across devices and platforms, the lack of accessible, standardized, and secure methods for integrating gesture-based input presents a serious barrier to inclusive interaction. Current gesture systems often require proprietary hardware, offer limited cross-platform support, or demand extensive reengineering of existing applications. This restricts adoption in key areas such as accessibility, low-touch user interaction, and rapid UI prototyping.

Developers seeking to enhance web or mobile applications with gesture capabilities currently face high technical overhead, inconsistent APIs, and privacy concerns. Without a modular, browser-native solution for integrating gesture recognition directly into the DOM, user experiences remain fragmented, and gesture input remains underutilized in mainstream applications. The inability to easily validate, map, and deploy gesture commands across varied UI components exacerbates security vulnerabilities and usability issues—particularly in high-stakes environments like authentication, e-commerce, and assistive technology platforms.

### SUMMARY OF THE INVENTION

The present invention discloses a computer-implemented system and method for enabling touchless gesture-based interaction with a digital user interface. The system operates by capturing user hand movements via a camera interface, processing the captured image data to extract hand landmark information, and classifying the movements into predefined gesture types using a gesture recognition engine executed on a client device.

The classified gesture types are mapped to corresponding user interface actions through a gesture-to-interface mapping module. These user interface actions are bound to target elements within a Document Object Model (DOM) of a web-based or application-based interface using selector-based identifiers.

An event injection module generates synthetic interface events corresponding to the mapped user interface actions and applies the events directly to the target DOM elements to execute the actions without requiring physical touch input.

The system is implemented as a plugin interface or software development kit (SDK) configured for integration into a host application. The plugin interface enables developers to define gesture-to-action mappings and DOM bindings through configuration parameters without modifying core application logic.

In some embodiments, the system operates entirely on the client device without transmitting image data to external servers, thereby preserving user privacy and reducing latency.

In certain embodiments, additional modules may be included, such as context management, feedback rendering, or adaptive gesture configuration; however, such modules are optional and do not alter the core operation of gesture capture, classification, mapping, and event injection. These features are provided as optional embodiments and are not required for operation of the core gesture-to-interface mapping system.

### Functional Benefits

The disclosed invention provides a modular and extensible system for integrating gesture-based input directly into existing digital interfaces without requiring proprietary hardware or invasive code changes. Through gesture integration plugins, cross-platform middleware, and secure developer SDKs, this system offers the following functional benefits:

Seamless Gesture Enhancement: Developers can easily overlay gesture capabilities such as drag-and-drop, clicks, and form submissions onto existing web and mobile applications using browser-compatible plugins.

Standardized API Access: A unified interface allows developers to detect, validate, and respond to gesture input across devices and operating systems, promoting consistency, and reducing development complexity.

Secure DOM-Level Control: The SDK provides granular binding of gestures to specific UI elements, ensuring that interactions are contextual, validated, and protected against spoofing or injection attacks.

DOM-Level Web Integration: Operates within a web browser using technologies such as WebAssembly, TensorFlow.js or similar, allowing direct interaction with login forms and eliminating the need for proprietary software or hardware.

Rapid Integration: The middleware and plugins operate client-side with minimal setup, allowing quick deployment in real-time applications, including accessibility tools, smart forms, and gesture-based navigation systems.

Privacy-Centric Design: All processing occurs locally in the user's browser or device environment, ensuring that gesture data remains private and secure by default.

This framework reduces friction in bringing gesture interactivity to applications while enhancing security, user experience, and platform compatibility.

### Key Innovative Aspects

The present invention introduces several novel components and architectural advances that differentiate it from prior systems and approaches.

Plugin-Based Gesture Augmentation: Enables any standard HTML form or user interface to be upgraded with gesture input capabilities without rewriting frontend code, allowing rapid deployment across legacy and modern systems.

Cross-Platform Gesture Middleware: Acts as an intermediary layer between input devices (standard webcams) and application logic, allowing consistent gesture handling across desktop, mobile, and web environments.

Secure DOM Gesture SDK: Offers a development toolkit that maps gestures directly to DOM elements with contextual validation and isolation, ensuring secure and reliable user interaction without disrupting existing app logic.

Context-Aware Gesture Binding: Supports dynamic gesture mapping based on active UI context, allowing different gestures to perform distinct functions depending on the state of the application.

Gesture Execution Verification Layer: Introduces gesture-bound validation mechanisms that ensure user input is deliberate, complete, and compliant with interaction requirements—particularly useful for authentication, form validation, and CAPTCHA-like mechanisms.

Lightweight, Browser-Native Implementation: Designed for performance and accessibility, the system uses WebAssembly, TensorFlow.js, ONNX or similar models to ensure real-time gesture recognition within client-side environments.

These innovations collectively establish a flexible and developer-friendly ecosystem for gesture-enhanced application design, addressing long-standing integration, privacy, and usability challenges.

### BRIEF DESCRIPTION OF THE FIGURES

FIG. 1 is a high-level system architecture diagram (100) of a Gesture-Based Interface Plugin and Integration SDK. The diagram illustrates a modular processing pipeline for enabling touchless gesture-based interaction with a digital user interface.

The system includes an SDK Initialization Handler (102) configured to initialize the gesture processing environment within a host application and coordinate activation of gesture-related modules. A Gesture Capture Adapter (106) is configured to capture a sequence of image frames representing hand movements of a user via a camera interface.

The captured image frames are processed by a Gesture Classifier (110), which extracts hand landmark data and classifies the hand movements into one or more predefined gesture types. The classified gesture types are transmitted to a Command Dispatcher (114), which maps each gesture type to a corresponding user interface action based on predefined configuration parameters.

A DOM Mapper (116) is configured to bind the corresponding user interface action to at least one target element within a Document Object Model (DOM) using selector-based identifiers. The Command Dispatcher (114) cooperates with the DOM Mapper (116) to facilitate execution of the mapped actions.

The system further includes an event execution mechanism configured to generate and apply synthetic interface events to the target DOM elements to effect execution of the corresponding user interface actions without physical touch input.

In some embodiments, the system may include additional modules such as Error Recovery & Retry Logic (124), Gesture-to-Voice Command Bridge (126), Analytics Hook (128), Session-Aware Profile Loader (130), Inclusify.js Adapter (132), AirFrame Integration (134), SignVerify Auth Module (136), and Modular Suggestion Engine (138). These modules provide optional functionality including adaptive configuration, feedback processing, multimodal interaction, and analytics, and do not alter the core gesture capture, classification, mapping, and event execution pipeline.

The architecture defines a client-side processing flow from gesture capture to user interface action execution, enabling integration of touchless interaction capabilities into web-based and application-based environments through a plugin interface.

FIG. 2 is a high-level architectural diagram (200) illustrating an execution environment for a Gesture-Based Plugin and Browser Extension system. The diagram represents interaction between a gesture processing plugin and a host application within a runtime environment.

The system includes a Content Script (202) configured to be injected into a target web page based on rules defined in a Manifest File (204). The Content Script (202) loads gesture processing modules and establishes communication between the host application and the gesture processing system.

A Background Script (206) is configured to manage message passing between components of the system, including communication between the Content Script (202), a Popup Window (208), and external services. The Popup Window (208) provides a user interface for enabling, disabling, or configuring gesture-based interaction features.

The Content Script (202) interfaces with a host application (210) by detecting and interacting with Document Object Model (DOM) elements and by receiving or dispatching custom interface events. A Permission Layer (212) defines authorized domains, resource access, and execution scope for the system, while a Storage Layer (214) is configured to persist configuration data, gesture mappings, and session-related information.

A build and deployment framework includes Developer Source Code (220) processed by Build & Deployment Tools (216) to generate executable plugin or extension artifacts. An API Gateway (218) may be used in some embodiments to manage access control, usage monitoring, or external service integration.

User interaction is represented by User Gesture Input (222), which is captured and processed by the gesture processing system, and User UI Events (224), which include interface interactions such as configuration changes. User Identity data (226) may be used in some embodiments for session management or access control.

The architecture illustrated in FIG. 2 defines a runtime integration environment in which gesture-based interaction is injected into an existing application without modification of core application logic, enabling execution of gesture-driven interface actions through plugin-based deployment.

### DETAILED DESCRIPTION OF FIGURES

The modules described herein may be selectively implemented, and not all modules are required for core system operation. These features are provided as optional embodiments and are not required for operation of the core gesture-to-interface mapping system.

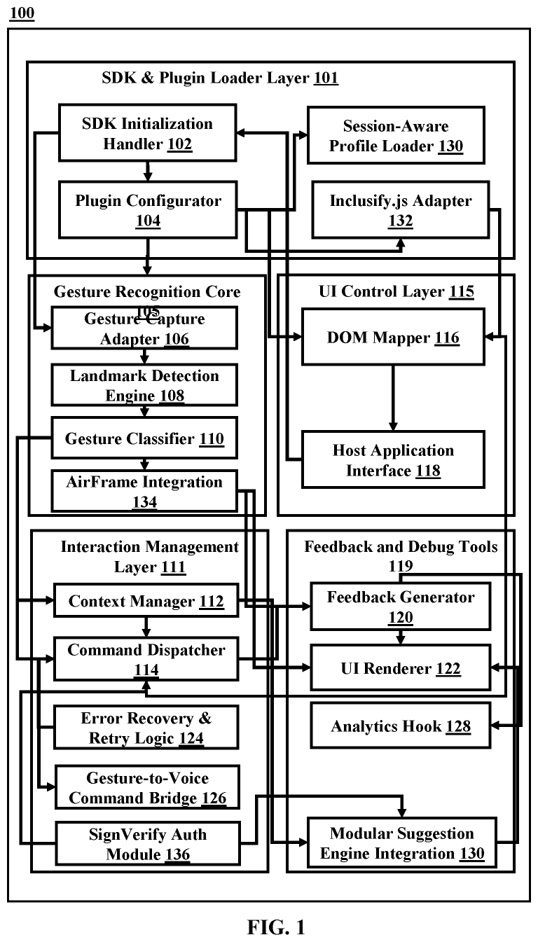

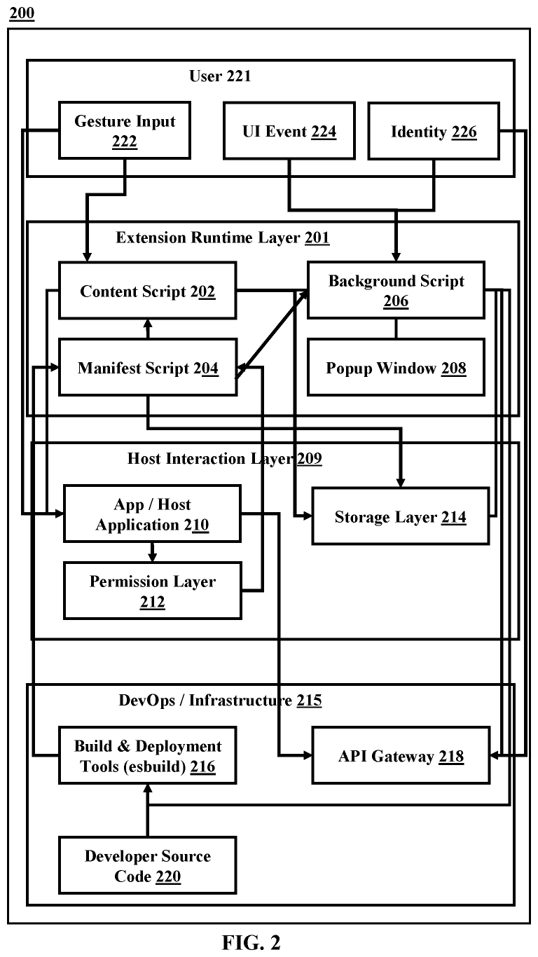

FIG. 1 illustrates the overall architecture (100) of a system designed for Gesture-Based Interface Plugin and Integration SDK. The system architecture (100) is composed of the following grouped components:

SDK & Plugin Loader Layer (101) Initializes the gesture recognition system and loads user-defined configurations, enabling flexible setup and dynamic integration into host applications.

SDK Initialization Handler (102): This module initiates the gesture SDK at runtime within a host application. It injects middleware hooks into the application lifecycle to facilitate seamless integration. It establishes upstream communication with the Gesture Capture Adapter (106). The SDK Initialization Handler (102) receives control from the Host Application Bootstrap and initiates the Gesture Capture Adapter (106) to begin video stream capture.

Plugin Configurator (104): Responsible for loading and parsing external configuration files containing gesture profiles, language models (e.g., ASL, BSL), and UI element bindings. This component enables customization of gesture behavior per implementation. Plugin Configurator (104) receives initialization signals from the SDK Initialization Handler (102) and subsequently sends configuration data to both the DOM Mapper (116) and the Gesture Recognition Core (105).

Gesture Recognition Core (105): Processes raw camera input to extract hand landmarks and classify gestures using AI models, forming the foundation of gesture interpretation. Gesture Capture Adapter (106): Captures real-time video streams using standard web or mobile camera APIs and performs frame buffering for downstream processing. The SDK Initialization Handler (102) connects to the Landmark Detection Engine (108) to initiate hand and finger keypoint extraction after setting up the gesture capture pipeline.

Landmark Detection Engine (108): Applies AI-based landmark detection models such as MediaPipe or ONNX-based extractors to identify hand/finger points. These landmarks are critical for inferring gesture types. The Gesture Capture Adapter (106) connects to the Gesture Classifier (110) by transmitting processed visual data, enabling the classification of gesture types based on captured hand movements.

Gesture Classifier (110): Utilizes convolutional neural networks (CNNs) or similar ML techniques to classify gesture types (e.g., tap, drag, hold, scroll) based on the landmark data. The Landmark Detection Engine (108) sends extracted gesture landmark data to both the Gesture Classifier (110) and the Context Manager (112) to enable accurate gesture classification and contextual mode determination.

Interaction Management Layer (111): Maintains contextual awareness of the user interface and maps classified gestures to specific UI commands based on mode and interaction context.

Context Manager (112): Maintains contextual awareness of the UI state (e.g., input field active, navigation mode, authentication pending). Determines mode switching logic for dynamic interaction routing. The Gesture Classifier (110) transmits classified gesture data to the Command Dispatcher (114) to enable the mapping of recognized gestures to specific UI actions.

Command Dispatcher (114): Translates recognized gestures into executable UI actions based on user-defined mappings and current context. Routes these commands to the DOM Mapper and Feedback Generator. The Command Dispatcher (114) receives classified gestures from the Gesture Classifier (110) and contextual information from the Context Manager (112), then forwards the resulting UI action commands to the DOM Mapper (116) and the Feedback Generator (120) for execution and user response visualization.

UI Control Layer (115): Identifies interface elements and applies gesture-driven commands to host applications, enabling seamless, DOM-level interaction.

DOM Mapper (116): Detects and maps active DOM/UI elements using CSS selectors or bounding box calculations. Ensuring gestures are applied to the correct interface regions or fields. The DOM Mapper (116) receives gesture bindings and UI configuration data from the Plugin Configurator (104), as well as mapped UI commands from the Command Dispatcher (114), and applies these interactions to the Host Application Interface (118).

Host Application Interface (118): Injects gesture-induced events into the host web or mobile application (e.g., triggering click events, submitting forms, focusing input fields). The Host Application Interface (118) receives gesture-driven events and mapped interactions from the DOM Mapper (116) to apply them directly to native UI components such as form fields, buttons, and containers.

Feedback and Debug Tools (119): Generates real-time visual feedback and developer-facing diagnostics to confirm gesture recognition outcomes and system behavior.

Feedback Generator (120): Provides system and user feedback, including gesture validation highlights, pointer color changes, and debugging logs for developers. The Feedback Generator (120) receives gesture-command mappings from the Command Dispatcher (114) and then transmits visual cues and debug data to the UI Renderer (122) for real-time display and user interaction confirmation.

UI Renderer (122): Renders visual updates such as overlay animations, pointer transformations, and result status indicators (e.g., green =success, red =error). The UI Renderer (122) receives input from the Feedback Generator (120) and renders pointer states, validation messages, and debug overlays on the host application's interface to provide real-time visual feedback.

Error Recovery & Retry Logic (124): The Error Recovery & Retry Logic module improves robustness by monitoring failed or uncertain gesture classifications and triggering guided recovery workflows. It interfaces with the Command Dispatcher to evaluate confidence thresholds and determine when to prompt retry actions or reset gesture state. This component ensures a smoother user experience by minimizing false negatives and offering real-time correction opportunities during interaction.

Gesture-to-Voice Command Bridge (126): The Gesture-to-Voice Command Bridge enables multimodal interaction by translating recognized gestures into equivalent voice command triggers. Integrated with the Command Dispatcher, this module routes gesture events to external voice APIs or local voice interface components, allowing hybrid input for users who benefit from both modalities. It's particularly useful for accessibility scenarios where users alternate between visual and auditory communication methods.

Analytics Hook (128): The Analytics Hook tracks and logs key gesture interaction metrics, such as success/failure rates, command latency, navigation bottlenecks, and element-level heatmaps. It connects to the Feedback Generator to gather real-time usage data and forwards aggregated insights to external monitoring systems or developer dashboards. This data-driven module supports iterative UX improvements and system tuning by offering visibility into live user behavior.

Session-Aware Profile Loader (130): The Session-Aware Profile Loader dynamically personalizes the gesture experience by loading user-specific gesture profiles based on session metadata such as locale, device type, orientation, and current application state. It works alongside the Plugin Configurator to inject appropriate language models, UI bindings, and gesture configurations. This enhances usability across multilingual, accessible, and adaptive environments by ensuring that gesture behavior is contextualized to the user's session characteristics.

Inclusify.js Adapter (132): The Inclusify.js Adapter enables seamless integration of accessibility features into gesture-based applications by bridging gesture recognition logic with modern web accessibility standards. Loaded via the Plugin Configurator, it injects accessible DOM mappings and user interface bindings based on gesture profiles, ensuring inclusive design principles are respected across UI elements. It connects directly to the DOM Mapper, allowing gesture-triggered actions to comply with screen reader compatibility and semantic accessibility tags.

AirFrame Integration (134): AirFrame Integration provides a bridge between gesture recognition and advanced motion-based rendering models. It connects to the Gesture Classifier to receive classified gestures, then forwards data to the Feedback Generator and UI Renderer for dynamic animation or video synthesis. This module supports gesture animation preview, real-time avatar modeling, and AI-generated instructional content, enriching user interaction through visual storytelling.

SignVerify Auth Module (136): The SignVerify Auth Module handles secure authentication through gestures, supporting password entry, OTP input, and CAPTCHA-style verification workflows. Receiving classified gestures from the Gesture Classifier, it communicates with the Context Manager to determine the active validation context and invokes the Modular Suggestion Engine to aid users with character or action suggestions. Its output ensures validated authentication flows without requiring physical input devices, reinforcing the system's touchless identity framework.

Modular Suggestion Engine (138): The Modular Suggestion Engine provides real-time, context-aware recommendations during gesture input, including characters, command buttons, or OTP elements. It connects both the Context Manager and SignVerify Module to align suggestions with authentication mode and user progress. Output from this engine is relayed to the Feedback Generator, which visually presents the suggestions through the UI Renderer. The engine supports privacy controls such as disabling in presentation mode and enforcing session-specific behavior based on active profiles.

FIG. 2 illustrates the overall architecture (200) of a system designed for a Gesture-Based Plugin and Browser Extension. The system architecture (200) is composed of the following grouped components:

Content Script (202): Executes upon loading a matching URL, as defined in the Manifest File (204). This script acts as the bridge between the web page and the extension, injecting gesture modules and optionally launching secondary scripts (e.g., for automated text capture or bot functionalities). It communicates bidirectionally with the Background Script (206) using message passing.

Manifest File (204): Serves as the control center for the extension's behaviors specifying required permissions, identifying the URLs to match, and declaring content script execution order. It enables inter-component communication and grants runtime access to the extension for specific domains.

Background Script (background.js) (206): Handles messaging across the extension, managing both internal (e.g., between popup and content script) and external (e.g., with the host application) communication. It also listens for state updates, API triggers, and user actions.

Popup Window (208): Provides a lightweight user interface that launches alongside the content script. It interacts exclusively through the Background Script [206], reflecting settings, activation status, or captured data. The popup does not directly communicate with the web page.

App/Host Application (210): Refers to the actual web application where gesture functionality is embedded. It dispatches and receives data via Custom Events, handled by the Content Script. The app may also interact with external services through Backend APIs for validation or data processing.

Permission Layer (212): Defined in the manifest, this layer specifies allowed URLs, messaging scopes, and storage access (e.g., activeTab, storage, host_permissions). It ensures secure operation and restricts extension capabilities per user consent.

Storage Layer (214): Utilizes localStorage and browser. storage. local to persist encrypted keys, configuration settings, and user-specific data. It allows seamless state continuity across sessions while supporting secure gesture profile retrieval.

Build & Deployment Tools (216): Uses esbuild to generate optimized, minified JavaScript bundles suitable for both Chrome and Safari environments. The project template (e.g., esbuild-react-chrome-extension) streamlines multi-platform packaging.

API Gateway (218): A centralized service for managing SDK users, monitoring plugin usage, and enforcing authentication/authorization for advanced features (e.g., premium gesture sets or custom profile loading).

Developer Source Code (220): Developer Source Code forms the foundation of the plugin system, encompassing all JavaScript/TypeScript logic, React components, gesture modules, manifest configurations, and service hooks. This codebase is processed through build tools like esbuild to generate optimized output for both Chrome and Safari environments. It serves as the origin point for Content Script (202), Background Script (206), and the Manifest File (204), and determines the system's runtime behaviors, UI elements, and gesture recognition logic.

User Gesture Input (222): This refers to hand movements and in-air gestures performed by the user, captured through the device's webcam and interpreted by the Content Script (202). These inputs are classified and mapped to UI actions or authentication data by the gesture recognition system.

User UI Event (224): Covers direct interactions such as clicking the extension icon, opening the popup, or adjusting settings. These events are handled by the Popup Window (208) and passed to the Background Script (206) for routing and processing.

User Identity (226): Includes the authenticated identity of the user captured through SignVerify gestures, tokens, or session metadata. This data may be used for secure communication with the API Gateway (218), session-aware personalization, or gesture profile loading via the Session-Aware Profile Loader (130).

### Detailed Description of the Invention

The present invention discloses a modular, gesture-based interface plugin and SDK system designed to integrate seamlessly into existing web and application environments, enabling developers to augment UI interactions with touchless gesture inputs. This system facilitates drag, click, hold, and scroll functionality using standard consumer-grade cameras, making it suitable for a wide range of accessibility, productivity, and secure input use cases.

The system architecture comprises multiple interrelated layers:
(1) SDK & Plugin Loader Layer (101): This layer initializes the gesture interface at runtime. The SDK Initialization Handler (102) hooks into the host application's lifecycle, preparing the system for gesture capture. The Plugin Configurator (104) then loads predefined configurations, including gesture dictionaries, UI bindings, and selected gesture languages (e.g., ASL, BSL). The Inclusify.js (132) Adapter enables seamless integration of accessibility features into gesture-based applications. This configuration ensures that the gesture system adapts to the host application's structure and requirements.
(2) Gesture Recognition Core (105): This core processing unit captures and interprets raw visual input. The Gesture Capture Adapter (106) accesses the camera stream using platform-native APIs and feeds the visual data to the Landmark Detection Engine (108), which uses AI models (e.g., TensorFlow. js or ONNX) to detect keypoints of hands and fingers. The Gesture Classifier (110) interprets these keypoints to classify gesture types (e.g., tap, drag, hold, scroll) and passes this semantic output to downstream modules for further processing. The AirFrame (132) Integration provides a bridge between gesture recognition output and advanced motion-based rendering models.
(3) Interaction Management Layer (111): In this layer, the Context Manager (112) monitors the interaction context such as whether the user is navigating, entering text, or authenticating and informing the Command Dispatcher (114). The dispatcher then maps classified gestures to UI-specific actions like clicking a button, submitting a form, or focusing on an input field, depending on context and developer-configured mappings. The Error Recovery & Retry Logic module (124) improves robustness by monitoring failed or uncertain gesture classifications and triggering guided recovery workflows. The Gesture-to-Voice Command Bridge (126) enables multimodal interaction by translating recognized gestures into equivalent voice command triggers. The SignVerify Auth Module (136) handles secure authentication through gestures, supporting password entry, OTP input, and CAPTCHA-style verification workflows.
(4) UI Control Layer (115): The DOM Mapper (116) interprets which UI elements should respond to gestures by analyzing the DOM structure, bounding boxes, or selector-based mappings. It communicates with the Host Application Interface (118), which applies gesture-generated events (e.g., mouse clicks, focus events) directly to the application's UI in real time.
(5) Feedback and Debug Tools Layer (119): To enhance transparency and assist developers during implementation, the Feedback Generator (120) creates real-time visual indicators such as pointer color changes and overlays indicating gesture recognition state or action success/failure. The UI Renderer (122) reflects these visual cues dynamically in the application interface, supporting both user-facing feedback and developer debugging logs. The Modular Suggestion Engine provides real-time, context-aware recommendations during gesture input, including characters, command buttons, or OTP elements (130).
(6) Extension Runtime Layer (201): This layer encompasses the core components that operate within the browser's extension environment. It includes the Content Script (202), which injects gesture-handling logic into target web pages; the Manifest File (204), which defines the scope, permissions, and execution criteria of the extension; and the Background Script (206), which manages communication between components such as the Popup Window (208) and external services. This layer ensures coordinated execution and message routing across the extension's runtime context.
(7) Host Interaction Layer (209): The Host Interaction Layer facilitates the exchange of data and events between the extension and the web application it interacts with. It includes the App/Host Application (210), which triggers and receives Custom Events; the Permission Layer (212), which enforces domain access and API communication rules; and the Storage Layer (214), responsible for persisting configuration data, encrypted credentials, or session metadata. This layer forms the interface between the extension and its operational environment.
(8) DevOps and Build Infrastructure Layer (215): This layer supports development, packaging, and deployment of the browser extension. It begins with Developer Source Code (220), which includes all logic and configuration files. These are processed by Build & Deployment Tools (216) like esbuild to generate optimized extension bundles for Chrome and Safari. The API Gateway (218) monitors SDK usage, manages authentication, and logs operational metrics, ensuring secure and controlled deployment across platforms.
(9) User Interaction Layer (221): This layer represents all interactions initiated by the user. It includes User Gesture Input (222), which is captured through a camera and interpreted via gesture recognition, User UI Events (224) like clicks or form interactions processed through the extension interface, and User Identity (226), representing authenticated data used for secure validation. This layer completes the loop between user behavior, system response, and security enforcement.

The system described provides a scalable, cross-platform, browser-compatible, and mobile-ready gesture interface without requiring specialized hardware or extensive code modification in the host environment. By modularizing each function from initialization, recognition, dispatch, and DOM mapping to feedback rendering the invention ensures consistent, responsive, and customizable gesture-based interaction across both legacy and modern UI systems. As shown in FIG. 1, the architecture integrates layered SDK components for gesture capture and execution, while FIG. 2 illustrates the complementary browser extension framework that enables seamless deployment within standard web and mobile environments through coordinated content scripts, background messaging, and host application integration. Together, these models support real-time, touchless interaction for accessibility, authentication, and input augmentation.

### Conclusion

The disclosed invention introduces a novel, extensible, and developer-centric architecture for integrating touchless gesture recognition into existing digital interfaces through plugins, browser extensions, and embeddable SDKs. Unlike traditional gesture systems constrained by proprietary hardware or native-only toolkits, this solution leverages consumer-grade cameras and browser-native technologies to enable seamless gesture input integration across platforms.

By modularizing gesture capture, classification, binding, and command dispatch into reusable components as detailed in FIG. 1, the system empowers developers to rapidly prototype, deploy, and adapt gesture-enabled layers within web, mobile, and cross-environment contexts. The plugin and browser extension architecture outlined in FIG. 2 further allows effortless deployment in real-world applications using content scripts, messaging protocols, and declarative permissions, supporting use cases from UI navigation and form control to secure authentication and assistive accessibility.

The system enables gesture-based interaction using standard camera hardware and browser-compatible technologies, allowing deployment within existing application environments without requiring specialized devices. The architecture supports scalable integration of gesture input with user interface elements through a plugin-based framework that operates within conventional software development workflows.

1. A computer-implemented system for enabling touchless gesture-based interaction with a digital user interface, the system comprising: a camera interface configured to capture a sequence of image frames representing a user's hand movements within a physical environment; a gesture recognition engine executed on a client device, the gesture recognition engine configured to process the sequence of image frames to extract hand landmark data and classify the hand landmark data into one or more predefined gesture types; a gesture-to-interface mapping module configured to associate each of the one or more predefined gesture types with a corresponding user interface action and bind the corresponding user interface action to at least one target element of a Document Object Model (DOM) of a web-based or application-based interface using element identifiers or selector-based references; an event injection module configured to generate one or more synthetic interface events corresponding to the associated user interface action and apply the one or more synthetic interface events directly to the at least one target element within the DOM to effect execution of the user interface action without physical touch input; and a plugin interface configured to be embedded within a host application, the plugin interface exposing one or more configuration parameters that enable a developer to define gesture-to-action mappings and target element bindings without modification of core application logic.

2. The system of claim 1, wherein the gesture-to-interface mapping module is further configured to map the one or more predefined gesture types to target elements of the DOM using selector-based identifiers including at least one of CSS selectors, element IDs, class names, or bounding region coordinates.

3. The system of claim 1, wherein the gesture recognition engine is configured to extract hand landmark data using a machine learning model trained to detect spatial positions of hand joints and finger points from the sequence of image frames.

4. The system of claim 1, wherein the event injection module is configured to generate synthetic interface events comprising at least one of a click event, drag event, scroll event, hover event, focus event, or text input event.

5. The system of claim 1, wherein the plugin interface is configured to dynamically load gesture-to-action mappings from a configuration file or runtime input without requiring recompilation of the host application.

6. The system of claim 1, further comprising a context management module configured to determine an interaction mode based on a current state of the user interface, and to modify the associated user interface action based on the determined interaction mode.

7. The system of claim 1, further comprising a feedback module configured to render a visual overlay within the user interface indicating recognition of a gesture and execution status of the corresponding user interface action.

8. The system of claim 1, wherein the system is configured to execute the gesture recognition engine entirely on a client device without transmitting image data to a remote server.

9. The system of claim 1, wherein the plugin interface is configured to be deployed within at least one of a web browser environment, a browser extension, a mobile webview, or a native application runtime.

10. The system of claim 1, wherein the gesture-to-interface mapping module is further
configured to restrict application of the synthetic interface events to a defined subset of DOM elements based on access control rules or security constraints.

11. A computer-implemented method for enabling touchless gesture-based interaction with a digital user interface, the method comprising: capturing, via a camera interface of a client device, a sequence of image frames representing hand movements of a user; processing, by a gesture recognition engine executed on the client device, the sequence of image frames to extract hand landmark data; classifying, by the gesture recognition engine, the hand landmark data into one or more predefined gesture types; associating, by a gesture-to-interface mapping module, each of the one or more predefined gesture types with a corresponding user interface action; binding, by the gesture-to-interface mapping module, the corresponding user interface action to at least one target element of a Document Object Model (DOM) using selector-based identifiers; generating, by an event injection module, one or more synthetic interface events corresponding to the associated user interface action; and applying the one or more synthetic interface events to the at least one target element within the DOM to execute the user interface action without physical touch input..

12. A non-transitory computer-readable medium storing instructions that, when executed by one or more processors of a client device, cause the client device to perform operations comprising: capturing a sequence of image frames representing hand movements of a user; extracting hand landmark data from the sequence of image frames using a gesture recognition engine; classifying the hand landmark data into one or more predefined gesture types; mapping each of the one or more predefined gesture types to a corresponding user interface action; binding the corresponding user interface action to at least one target element of a Document Object Model (DOM) using selector-based identifiers; generating one or more synthetic interface events corresponding to the user interface action; and injecting the one or more synthetic interface events into the DOM to cause execution of the user interface action without physical touch input.

13. The method of claim 11, wherein binding the corresponding user interface action to the at least one target element comprises identifying the at least one target element using at least one of a CSS selector, element identifier, class name, or bounding region coordinate.

14. The method of claim 11, wherein processing the sequence of image frames comprises detecting spatial positions of hand joints and finger points using a machine learning model configured for landmark extraction.

15. The method of claim 11, wherein generating the one or more synthetic interface events comprises generating at least one of a click event, drag event, scroll event, hover event, focus event, or text input event.

16. The method of claim 11, further comprising determining, by a context management module, an interaction mode based on a current state of the digital user interface, and modifying the corresponding user interface action based on the determined interaction mode.

17. The method of claim 11, further comprising rendering, by a feedback module, a visual overlay within the digital user interface indicating recognition of a gesture and execution status of the corresponding user interface action.

18. The method of claim 11, wherein the processing, classifying, and applying steps are performed entirely on the client device without transmitting the sequence of image frames to a remote server.

19. The method of claim 11, wherein binding the corresponding user interface action further comprises restricting application of the one or more synthetic interface events to a defined subset of target elements based on access control rules.

20. The method of claim 11, wherein the method is executed within at least one of a web browser environment, a browser extension, a mobile webview, or a native application runtime.
